(19) United States
(12) Patent Application Publication
(10) Pub. No.: US 2006/0293992 A1
(43) Pub. Date: Dec. 28, 2006

(54) Life settlement contract based investment methods, systems, and products

(76) Inventor: Thomas Carlton Blair, Stamford, CT (US)

Correspondence Address: WINSTON & STRAWN LLP;PATENT DEPARTMENT, 1700 K STREET, N.W., WASHINGTON, DC, 20006, US

(21) Appl. No.: 11/476,442

(22) Filed: Jun. 27, 2006

Related U.S. Application Data
(60) Provisional application No. 60/694,612, filed on Jun. 27, 2005.
(60) Provisional application No. 60/714,702, filed on Sep. 6, 2005.

(51) Int. Cl. G06Q 40/00

(52) U.S. Cl. 705/35

(57) ABSTRACT

Investment or financing methods, systems and products that involve LSC-backing. An investment company invests funds directly into an operating company, partially for unrestricted use by the operating company, and partially to finance a hedge to protect the principal of the invested funds. The restricted portion of the invested funds are used to purchase life settlement contracts (LSCs) in a face amount equal to a percentage of the total amount of funds invested. The LSCs may be part of a pooled fund covering multiple insureds or may be purchased on an individual basis. Structured financial products, different classes of corporate security or bond issues, high risk investment and rather investments in which a primary investment may be integrated with an LSC-based secondary investment. Computer equipment for providing a user interface, investment administration, and electronic trading are also provided.

### RELATED PATENT APPLICATIONS

This application claims the benefit of U.S. Provisional Patent Application No. 60/694,612 filed Jun. 27, 2005, titled Principal Hedged Debt Financing, and the benefit of U.S. Provisional Patent Application No. 60/714,702 filed Sep. 6, 2005, which are both hereby incorporated herein by reference in their entirety.

### FIELD OF THE INVENTION

The present invention relates to life settlement contracts and, more particularly, to life settlement contract based financing and investment methods, products, and systems.

### BACKGROUND OF THE INVENTION

Presently, there is a large array of different types of financing and investment opportunities that are available to investors. Each of these different types of opportunities can offer investors different financial and performance characteristics (e.g., with respect to financial stability, rate of return, and investment structure). Many of such existing types of financing and investment opportunities, however, have drawbacks that include that they do not adequately protect the investor(s) with respect to the loss of the investor(s)' contribution to the investment or protect the expected cash flow from the investment (e.g., in the case of default). For example, one common area of investment involves investing in operating companies. Such companies generally require significant amounts of capital to develop a business, market the products (or services) of the business, and to pay for general and administrative expenses associated with company operations. Investors typically provide capital to such companies in exchange for equity, a debt obligation, or for other consideration. Often times, such companies are start-up companies that are in the early stages of development. Irrespective of whether a company is in a start-up phase or is a mature operating company, a significant amount of risk exists for investors who may lose all of their investment if the company fails.

In some prior art investment methods, an investment company uses investor contributions to invest in a particular business and to also obtain an insurance policy on the business to protect the investor contributions. Such methods, however, are tied to the fundamentals and business plan of the business of interest and are often times costly if, for example, the company is a startup.

Another field of investment involves life settlement contracts (LSCs). LSCs have been in existence since at least the 1980's. Essentially, an LSC provides a mechanism by which the owner of a life insurance contract, typically the insured, sells the life insurance contract to a buyer who becomes the beneficiary of the purchased LSC. When an LSC “matures,” the life insurance proceeds are paid to the buyer. In the interim, the buyer has the obligation to maintain the life insurance by paying the life insurance premiums. LSCs are typically purchased by buyers as a form of investment seeking to make a profit on the transaction. A certain category of LSCs is referred to as viaticals. Viaticals are generally considered to be LSCs that have a maturity of less than two years.

There is currently a great demand and activity in the investment and financial community that is related to LSCs. Such known activity has been primarily focused on the securitization of LSCs and advancing LSCs as a principal form of investment. However, there are a number of drawbacks to such efforts. For example, securitization requires compliance with a wide array of regulatory and exchange rules. With respect to holding LSCs as a principal form of investment, LSCs can provide a stable financial vehicle but they suffer from certain drawbacks such as the lack of a predetermined maturity or the lack of a current cash flow before maturity. In addition, even in the field of securitization, known techniques do not take advantage of the many features of LSCs to appropriately benefit investors such as to protect principal contributions of investors.

It would be desirable for methods, systems and products to be developed that take advantage of the many unique features of LSCs.

### SUMMARY OF THE INVENTION

In accordance with one embodiment, an investment company (e.g., a corporation, an individual investor, a group of investors, etc.) invests funds or other assets (e.g., by way of a direct contractual obligation) into an operating company in exchange for debt obligations, equity, or a combination thereof, wherein the funds are invested partially for unrestricted use by the operating company, and partially to finance a hedge to protect the invested funds. The restricted portion of the invested funds can be used to purchase life settlement contracts (LSCs) that have a face value equal to a percentage of the total amount of funds invested in the operating company (“Hedge Ratio”). The required maximum remaining average life expectancy of the insureds covered by the LSCs and the Hedge Ratio will vary depending upon the negotiations between the investment company and the operating company, and may also depend on various factors involving proximity of the operating company to profitability, strength of its assets, and general prospects for the operating company's success. The Hedge Ratio is selected to protect a percentage of the investor's investment. An investment company can make investments directly in individual operating companies, or by way of an investment entity such as a managed fund comprised of pooled investments in multiple operating companies.

If a direct investment into an operating company is pursued, LSCs can, for example, be held in escrow until the repayment of debt or return of investment to the investment company is achieved. As an alternative or in combination therewith, the LSCs can be purchased and owned by the investment company.

If desired, the terms of the arrangement may preferably provide a predetermined period of relief, generally, of at least one year, from repayment of debt and/or interest. For example, if the investment involves a current cash flow to the investors, the obligation to provide the cash flow can be suspended for a mutually agreed, predetermined time period (e.g., one year). In addition to protecting an investment by utilizing LSCs as a hedging tool, there are numerous other ways to protect against the potential loss of all or part of an investment. For example, the investment company can receive a security interest in the assets of the operating company or a preference position upon liquidation of the operating company.

Another alternative is for an investment company to form a second investment company which could own any combination of investment assets such as: mortgage-backed securities (“MBS”), commercial mortgage-backed securities (“CMBS”), collateralized mortgage-backed obligations (“CMO”), collateralized debt obligations (“CDO”), collateralized bond obligations (“CBO”), collateralized (leveraged) loan obligations (“CLO”), which is another type of asset backed securities (“ABS”), or other types of structured financial products. Thus, one or more of these structured products can be held by this second investment company, which those of ordinary skill in the art will understand might, for example, be a holding company or a trust. This second investment company would then hold such Structured Financial Products, in combination with LSCs which would offer protection to their principal value. Those of ordinary skill in the art will also understand that the second investment company can be a legal entity for providing a pool, fund, or other structure that would hold only a single investment issue (e.g., a particular issue of a structured financial product) or asset category (e.g., only CDOs), or can hold a combination of investment or financial issues, or categories. In each case, the value of the investment (e.g., the structured financial product, venture equity, pools, funds, etc.) would be enhanced (versus an identical vehicle or structure without LSCs), due to the value of the LSC hedge on the principal amount of capital invested due to the LSCs presumably high credit rating and typically stable and accreting value over time. In addition, in the context of multi-asset investments, the inclusion of LSCs in the pool of financial assets acquired by the investment company further diversifies the asset base, and as LSCs typically have a credit rating which is above—and a risk envelope which is below—that of the other assets in the investment, the investment as a whole, which can be a structured product, a pool, a fund, a direct contribution or other investment structure has a lower risk with the inclusion of LSCs among its assets.

The LSCs may be purchased from a pool of life settlement contracts covering multiple insureds (e.g., rather than purchasing individual LSCs, an interest in a pool of LSCs may be purchased). Alternatively or in combination therewith, the LSC assets designed to offer principal protection may take the form of some asset whose value is linked to or indexed to LSCs (an “LSC Derivative Asset”).

In some embodiments, a method for providing an integrated investment product can be implemented in which an investment fund is established that hedges a financial investment of its investors with LSCs. The fund is implemented to return at least a portion of the financial investment of one or more of the investors from the proceeds of LSCs such as when the fund is performing poorly (e.g., when a cash flow obligation to the investors cannot be met).

The fund can be established to have an investment objective, which can include investing in startup companies, investing in collateralized debt obligations (CDOs), commodities, options, foreign stocks, U.S. stocks, the technology section, blue chip stocks, bonds, etc. The fund may pay for ongoing premiums of the LSCs. The LSCs are, for example, held in escrow for the benefit of the investment fund. Alternatively, the LSCs are held in escrow for the benefit of the investors. One or more investors are paid from the proceeds of the LSCs if the investments made by the fund using the investors' contributions fails or another significant financial event occurs. To implement such an arrangement, the investment fund can enter into a binding obligation to hedge investor contributions in the fund with LSCs.

Other types of investments can also be combined with LSCs to protect against the risk of loss. For example, a method for providing an investment product to investors can be implemented that can integrate LSC and non-LSC investments. Investors can be offered to participate in an investment in which the investment has an intended revenue-generating source that is other than from LSCs. The method can further include integrating LSCs into the investment to protect a percentage of the financial contribution of the investors. The integration can involve purchasing LSCs (e.g., individually, or as a share in a pool of LSCs, etc.).

Certain LSC-backed investments involving debt instruments may have difficulty being assigned a maturity date since the individual(s) underlying the LSCs may significantly outlive their life expectancy(ies) creating an extended “tail” of the financial product. To remedy this problem, insurance can be obtained to place a final maturity date upon the financial product by providing insurance which would pay the face amount of each LSC that has outlived its life expectancy by a specified number of years.

The method can further comprise implementing a user interface for selecting to integrate LSCs with a primary investment. If desired, a tradable product can be issued that includes the LSC as a secondary component, whereby the tradable product could be traded on an electronic exchange.

Systems and financial products that, for example, implement or use such steps or processes are also contemplated as illustratively described herein.

### BRIEF DESCRIPTION OF THE FIGURES

Further features and aspects of the invention, its nature and various advantages will be more apparent from the following detailed description, taken in conjunction with the accompanying drawings in which like reference characters refer to like parts throughout, and in which:

FIG. 1 is a flow diagram illustrating a method for investing in a company in accordance with one or more embodiments of the present invention;

FIG. 2 is a flow chart of illustrative steps involved in embodiments in which maturity is specified for an LSC-based investment in accordance with one or more embodiments of the present invention;

FIG. 3 is a flow chart of illustrative steps involved in implementing LSC-backing in connection with a mutual fund in accordance with one or more embodiments of the present invention;

FIG. 4 is a flow chart of illustrative steps involved in LSC-backing investments in hedge funds, private equity funds, or other managed investments in accordance with one or more embodiments of the present invention;

FIG. 5 is a flow chart of illustrative steps involved in incorporating an LSC component into a business entity in accordance with one or more embodiments of the present invention;

FIG. 6 is a flow chart of illustrative steps involved in structured financial products having an LSC component in accordance with one or more embodiments of the present invention;

FIG. 7 is a flow chart of illustrative steps involved in securing LSCs as part of a transaction in accordance with one or more embodiments of the present invention;

FIG. 8 is a flow chart of illustrative steps involved in protecting contributions to high-risk investments in accordance with one or more embodiments of the present invention;

FIG. 9 is a flow chart of illustrative steps involved in implementing a user interface in accordance with one or more embodiments of the present invention;

FIG. 10 is an illustrative order entry display screen in accordance with one or more embodiments of the present invention;

FIG. 11 is a functional block diagram of an electronic exchange in accordance with one or more embodiments of the present invention;

FIG. 12 is a flow chart of illustrative steps involved in recording and administering an investment having an LSC component in accordance with one or more embodiments of the present invention;

FIG. 13 is a functional block diagram of computer equipment for implementing one or more steps or methods of one or more embodiments of the present invention; and

FIG. 14 is a flow chart of illustrative steps involved in purchasing LSCs for investment protection in accordance with one or more embodiments of the present invention.

### DETAILED DESCRIPTION OF PREFERRED EMBODIMENTS

The present invention, as illustratively described by the various embodiments provided herein, has as a goal to establish investment or financing vehicles in which a component of the vehicle is a protection mechanism involving LSCs, that protects investors against the loss of principal that can arise from the failure or default of the vehicle. Thus, the LSCs, whether directly or indirectly incorporated into the structure (e.g., by way of the terms of the investment or through investments having LSCs as an underlying asset) can provide a hedge, for example, for the principal contributed by the investors or the expected cash flow to the investors form the investment.

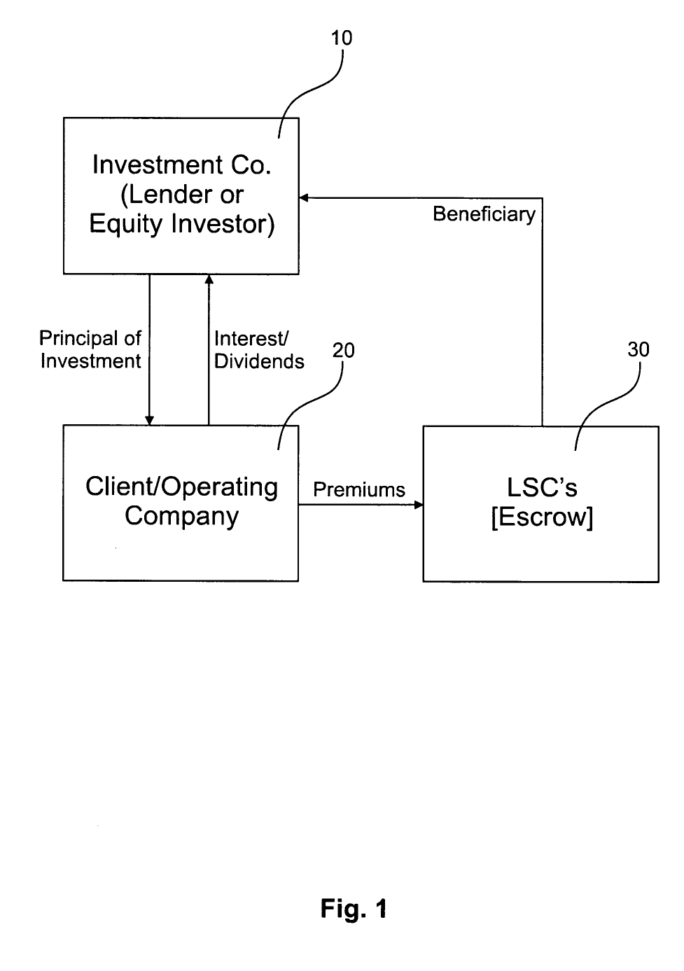

An investor's contribution can primarily be for investing in one or more financial vehicles such as a start-up company, funds, structure financial products, loans, pools, securities, bonds, etc. For example, with reference to FIG. 1, investment company 10, as shown, provides funds directly to an operating company, client company 20, as debt and/or equity. In the case of debt financing, the financing is provided pursuant to a negotiated agreement which provides for the repayment of the investment at some future time or in accordance with a predetermined schedule. Under the arrangement, if a cash flow obligation is involved (e.g., as part of a debt obligation), payments can be made periodically and, if desired, deferred for a period of time (e.g., one year). If investment company 10 provides equity to company 20, investment company 10 can receive a liquidation preference in the operating company in addition to the LSC hedge.

With a debt instrument, a conventional asset security can be granted to the investment company 10 by company 20.

As mentioned above, a restricted portion of the investment can be dedicated to protecting the investment of the company's invested funds. The restricted portion is preferably used to purchase life settlement contracts 30 (LSCs) in a face amount equal to a percentage of the total amount of the funds invested in the client company. The percentage can be negotiated between investment company 10 and company 20. Life settlement contracts 30 can preferably be held in escrow for the benefit of investment company 10 such that in the event of some form of financial default by company 20, investment company 10 can exclusively and directly benefit from the LSC holdings. Alternatively or in combination therewith, a security interest in LSCs 30 can be granted to investment company 10. The LSCs may be part of a pooled fund of life settlement contracts covering multiple insureds or may be purchased on an individual basis.

The required maximum remaining average life expectancy of the insureds covered by LSCs 30 and the Hedge Ratio can vary depending upon the negotiations between investment company 10 and operating company 20, and can depend upon various factors involving proximity of company 20 to profitability, strength of its assets, and general prospects for the company's success. LSCs 30 are normally held in escrow until repayment of debt or return of investment to investment company 10.

Further by way of example, company 20 may be an entity that has securitized a collection of assets or loan obligations such as by way of a conventional structured financial product. The securitized assets or loan obligations can be formally owned or held by company 20 or by a holding company, a trust, or other entity To implement a hedge for the investors in the securitized assets or loan obligations of company 20, a portion of the funds contributed by investment company 10 is used to purchase LSCs 30. Investment company 10 can be one or more individual investors, institutional investors, or other types of investors. LSCs 30 are preferably held in escrow.

In some embodiments, it is possible for investment company 10 to separately purchase LSCs as a hedging technique. However, in so doing, one or more advantages of integrating or tying the LSCs to the investment may not be achieved. For example, such an arrangement would not allow company 20 to possibly benefit both from the LSC proceeds for use in paying back company 10 and for company 20's own financial gain in appropriate circumstances. Those of ordinary skill in the art will understand that the LSCs are to be held in such a way that they hedge, secure, or guarantee the investors principal investment or expected financial benefit (e.g., current cash flow) during the time in which the investor principal has not yet been returned.

In some embodiments, a supplemental insurance can be incorporated into the transaction to provide certainty with respect to the maturity of the investment. The purpose of such insurance is to account for the possibility that although each LSC has an expected date of maturity, that date is not a certainty because it is tied to the mortality of the insured. This period, beyond the life expectancy of the LSCs, is sometimes referred to as the “tail.” Thus, the investment or financing structure or vehicle can be implemented to include an insurance asset to offset the possibility that one or more of the LSCs continues beyond the projected maturity date. The concept here is to provide certainty for the maturity date of the transaction and to protect against the financial impact of one or more LSCs maturing after their projected date of maturity (e.g., life expectancy). In some embodiments, the risk to the provider of the supplemental insurance can be minimized by, for example, selecting LSCs having a low likelihood of extending beyond a maturity obligation specified for the investment. With the inclusion of a predetermined maturity, the LSC-backed investment can be marketed, for example, by demonstrating to investors that the LSC-backed investment has characteristics that are similar to conventional investments such as bonds.

In some embodiments, the investment company can comprise an aggregator of LSCs, for example, an insurance company or a financial services company. In other embodiments, the investment company can utilize the services of an aggregator of LSCs. If desired, an aggregator of LSCs can provide coverage for the “tail” of a transaction.

An investment company can create a structured product comprising LSCs such as a fund comprising a combination of CMBS (commercial mortgaged backed securities), interest only bonds, and LSCs. The LSCs in the structured product can be used for debt or principal hedging. The investment company can set a desired maturity date for the structured product, for example, a principal return date or a debt repayment date. The LSCs that are assigned to the structured product can have an expected maturity date that is less than or equal to the maturity date of the structured product. For example, the LSCs that are selected for the structured product can be selected such that their expected maturity (e.g., life expectancy of the LSCs) is clearly before the maturity date of the structured product. For example, when a 10-year maturity is established, the investment company preferably buys LSCs of people who have a life expectancy of less than 10 years, for example, people who are at least 75 years old. An aggregator of LSCs can sell LSCs individually or as a pool. In some embodiments, an investment can include supplemental insurance (e.g., for the “tail”) that is purchased, for example, from an LSC aggregator. The aggregator can accept the position that if at some certain date beyond the life expectancy of an LSC that has not matured, the aggregator will pay for the payment that was expected from the unmatured LSC. The arrangement can be structured such that the aggregator can take over the remaining or unmatured LSCs so that the aggregator can benefit from the LSCs when they mature. To provide such a service, the aggregator can be paid insurance premiums during the term of the LSC-protected investment.

Preferably, a credit rating of A or higher should be required for the LSCs, but other credit rating levels could also be used.

An advantage of insuring the “tail” is that the uncertainty associated with an actual yield for investments that rely on LSCs to protect the investment principal can be eliminated. As such, an LSC related investment product or asset pool can be organized and marketed with a specific maturity. In other words, an issuer can set a maturity and possibly a rate of return for an LSC-backed investment product with the assurance that the maturity and rate of return will be met even if some of the LSCs have not matured as expected.

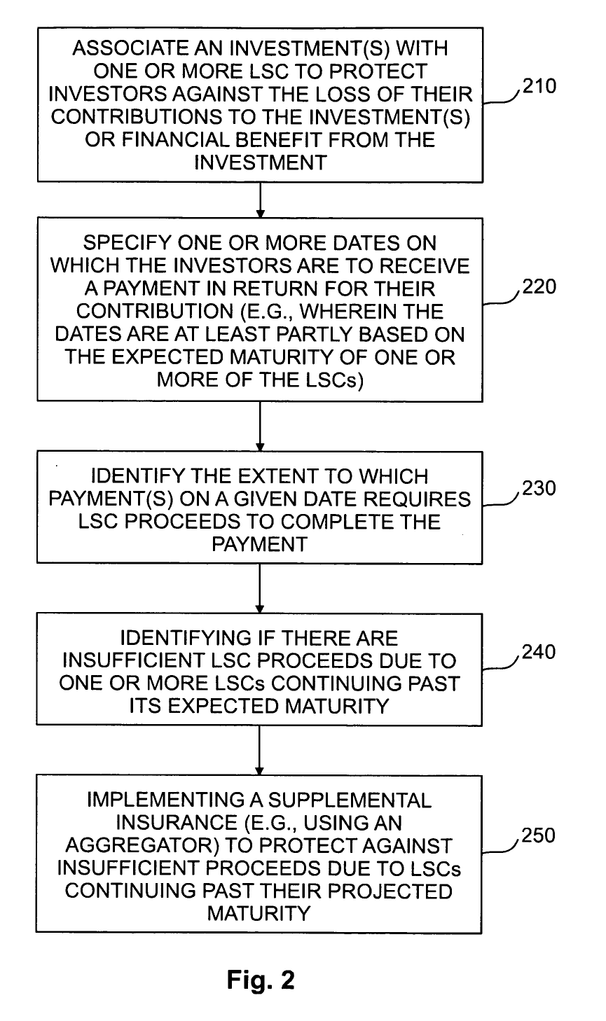

Illustrative steps relating to insurance for the “tail” of an LSC-based investment are shown in FIG. 2. With reference now to FIG. 2, at step 210, an investment is associated with one or more LSCs to protect investors against the loss of their contributions to the investment. An investment can, if desired, include one or more investments such as investments in different types of assets. At step 230, one or more dates on which the investors are to receive a payment in return for their contribution (e.g., periodic payments or a date of return of principal and/or interest, etc.) is specified. It is to be understood that a contribution does not necessarily have to be cash. A maturity date of a “tail” insured LSC-backed investment can be based on the projected maturity of the associated LSCs. At step 230, the extent to which a payment obligation on a given date requires LSC proceeds to satisfy that obligation is identified. Therefore, at step 230, it is identified whether the investment should now rely on the LSC backing so as to meet performance or financial obligations of the investment.

At step 240, it is identified if there are insufficient LSC proceeds to satisfy the payment obligation, wherein the insufficiency is as a result of one or more associated LSCs continuing past their projected maturity. At step 250, a supplemental insurance is implemented to protect against the contingency that there will be insufficient LSC proceeds due to some of the LSCs continuing past their expected maturity. The supplemental insurance may sometimes be referred to as insurance for the “tail,” thus establishing a final maturity date for the financial product, regardless of the ultimate maturity of the LSCs. The issuer of the supplemental insurance can, for example, be a company who is an aggregator of LSCs. The issuer can pay the expected proceeds for the post-maturity LSC and take ownership of the LSC so that it can receive the LSC proceeds when the LSC actually matures.

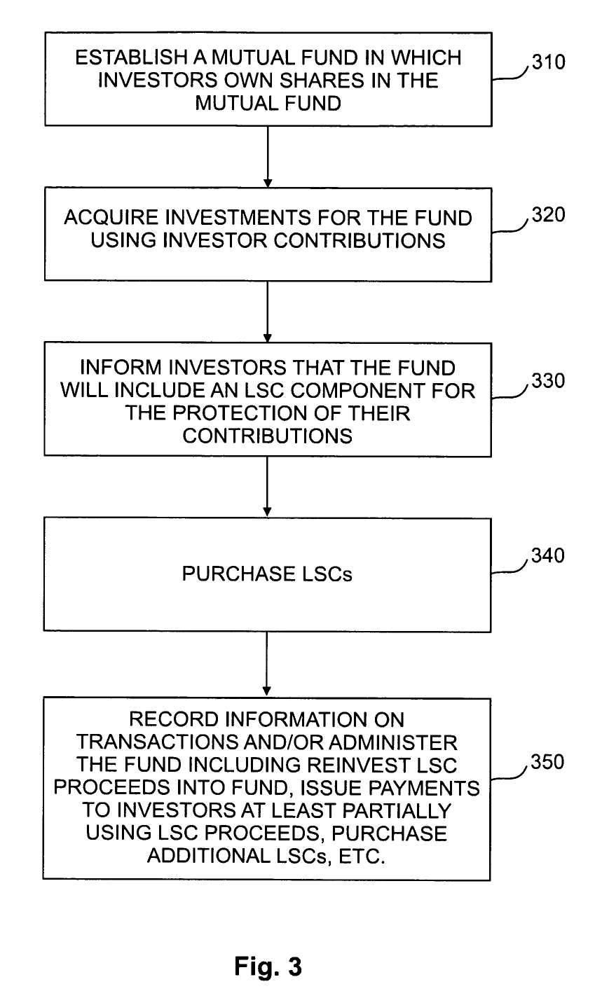

In the United States, investments that are considered public under government rules as opposed to private investments (e.g., not open to the public) are subject to greater regulation and oversight. LSCs can be used in either public or private investments to provide financial benefits to investors. For example, with respect to public investments, one implementation would be to incorporate LSCs into mutual funds. Illustrative steps involved in using LSC protection for mutual funds are shown in FIG. 3. At step 310, a mutual fund is established in which investors in the mutual fund own shares in the fund in accordance with their cash contributions. At step 320, investments (e.g. stocks, bonds, etc.) are acquired for the mutual fund using investor contributions.

At step 330, investors are informed that the fund will include an LSC component for the protection of their contributions. The LSC component can also provide a marketing tool for the mutual fund to drive participation. At step 340, LSCs are purchased for the mutual fund to protect investor contributions. The LSCs may be purchased to achieve a desired hedge ratio, which may have also been published for the investors. The maturity date of the LSCs are also selected to match the investment goals of the mutual fund. At step 350, information relating to mutual fund transaction activity (e.g., the buying and selling of securities, increases or decreases in investment value, payments to investors, etc.) are recorded. If desired, administration of the fund can be implemented to include LSC-related activity such as to reinvest LSC proceeds into the fund, to issue payments to investors at least partially using LSC proceeds, to purchase additional LSCs, or to perform other LSC related activity that may be needed in administering and continuing the investment and hedge protection activity of the fund.

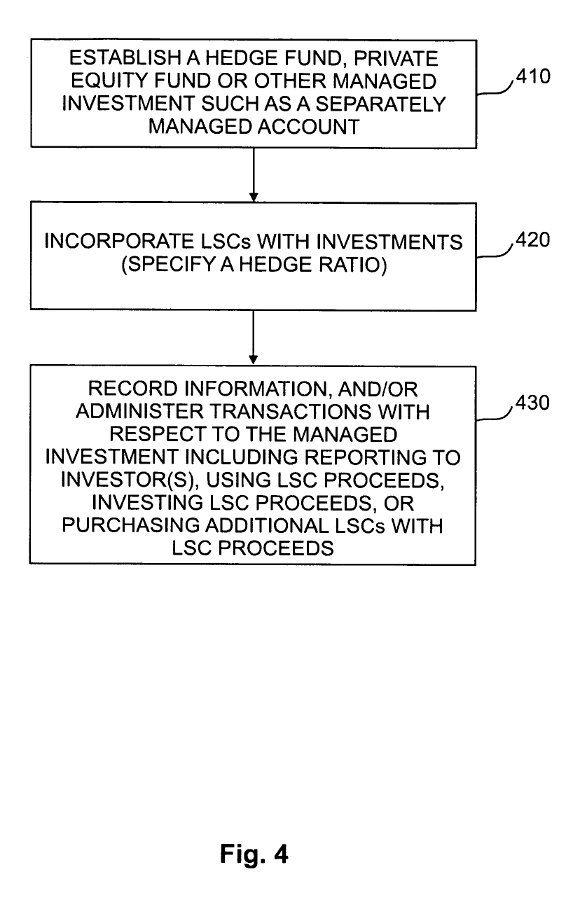

Other forms of funds or third party managed funds or accounts can also benefit from LSC protection. For example, with reference now to FIG. 4, at step 410, a hedge fund, private equity fund, or other managed investment (e.g., managed by a money manager) such as a separately managed account is established. At step 420, LSCs are incorporated into the managed investment such as by purchasing LSCs as part of the assets of the investment or by purchasing corresponding LSCs when new investment contributions are received. If desired, a hedge ratio is specified by the managed investment or specified (and agreed upon) by individual investors. Thus, for example, in a hedge fund, different investors can have different levels of LSC-backed hedge protection if desired. At step 430, information relating to the transactions of the managed investment (e.g., hedge fund, private equity fund, managed account, etc.) is recorded. If desired, LSC-related transactions with respect to the managed investments are administered such as by repaying investors using LSC proceeds, investing LSC proceeds, purchasing additional LSCs with LSC proceeds, etc.

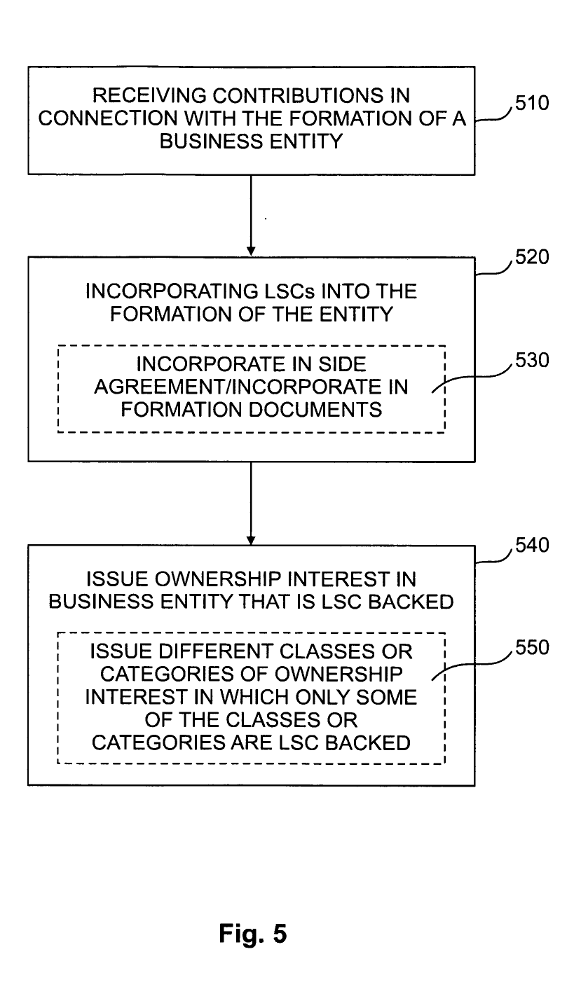

LSCs can also provide a protection mechanism by way of being integrated with the formation of a business entity such as a corporation, limited liability company, a partnership, etc. For example, with reference now to FIG. 5, at step 510, investment contributions can be received in connection with forming a business entity. At step 520, LSCs are incorporated into the formation of the entity as a form of investment protection for investors. At step 530, which can be a substep of step 520, LSCs can be incorporated into the business entity by using a side agreement, by incorporating LSCs into the formation related documents, or a combination thereof. Preferably, side agreements or other binding corporate documents will be used because formation documents for legal business entities are conventionally not used for limiting the characteristics of the business entity. At step 540, ownership interests in the business entity that is LSC backed are issued to investors. At step 550, which can be a substep of step 540, different classes or categories of ownership interest are issued in which only some of the classes or categories are LSC backed. For example, a corporation can issue different classes of stocks having different characteristics (e.g., preferred stocks or common stocks) wherein one class of stock is LSC backed so as to protect dividend and/or investment capital. If desired, the business entity may also issue an LSC-backed class of stocks (or, similarly, LCS-backed equity participation interests) subsequent to the initial formation of the entity.

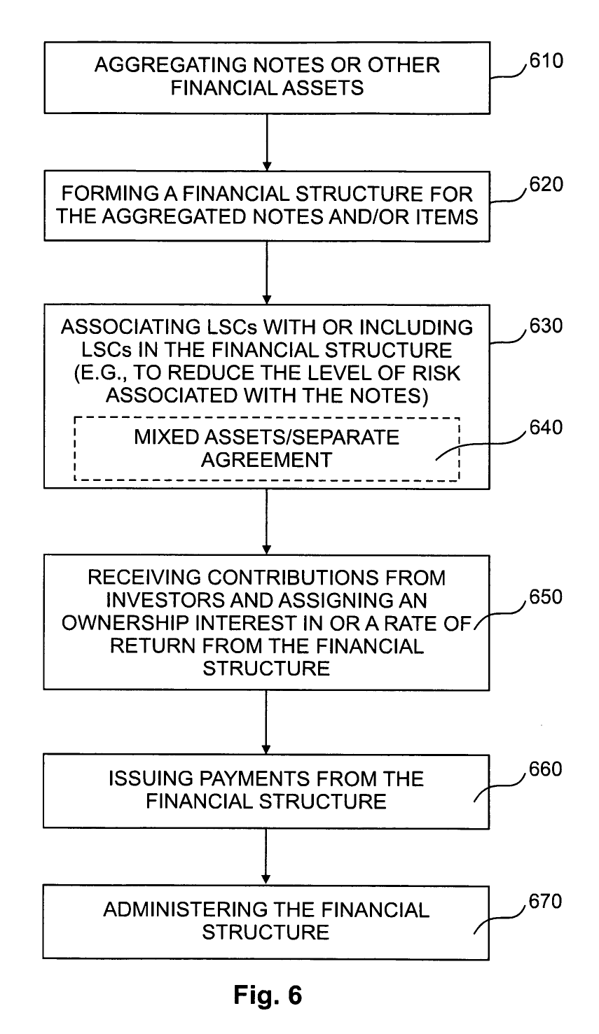

Structured financial products can also incorporate LSCs as a protection tool. Illustrative steps involved in implementing LSC-backed or incorporated structured financial products are shown in FIG. 6. With reference now to FIG. 6, at step 610, notes (e.g., loans, mortgages, etc.) or other financial assets (e.g., revenue producing financial items) are aggregated. At step 620, a financial structure for the aggregated notes and/or items is formed. At step 630, LSCs are associated with or included in the financial structure. The LSCs will, for example, reduce the level of risk associated with the notes. At step 640, which can be a substep of step 630, the LSCs can be integrated into the financial structure (e.g., wherein the financial structure involves securitization of the mixed assets). Alternatively, or in combination therewith, LSCs can be associated with the aggregated notes or other financial assets in the financial structure by way of a separate agreement that would benefit some or all investors with LSC backing of their investment. Tranches may also be established, which can be used to establish one or more tranches having an LSC component benefiting some investors, but not necessarily all investors.

At step 650, contributions are received from investors in exchange for assigning investors an ownership interest in, a specified rate of return from, or other interests in the financial structure. For example, the investors would own shares in the LSC-backed financial structure, or, for example, the financial structure would provide a bond-type arrangement. At step 660, the performance of the financial structure results in payments being issued to the investors. At step 670, which can be implemented at the same time as steps 650 and 660, the financial structure is administered preferably using computer equipment to maintain a database of records for the financial structure, to reflect activity, to calculate performance, and to account for variations in value and principal over the life of the financial structure.

FIG. 6 is applicable to implementations of structured financial products having an LSC component. Examples of commonly used structured financial products include collateralized mortgage backed securities, credit card backed securities, auto loan backed securities, student loan backed securities, and collateralized debt obligations. These products could be private or public offerings. Investor demands and current laws and regulations drive the techniques that are used to form such financial structures and the types of assets that can be included in the structure.

For example, for collateralized mortgage backed securities, a qualified trust is used for the financial structure. In such products, mortgages owned by one or more lenders are aggregated and held in a qualified trust, which is otherwise known as a REMIC trust. Once established, the trust pays interest and possibly principal to investors in the financial structure. Different classes of notes (ownership interest in the structure) can be issued (e.g., A, AAA, B, C classes). Interest and waterfall provisions would be prioritized among the different classes. In a REMIC trust, the tax laws may not permit a mixing of asset types within the trust. As such, the REMIC trust would likely only hold mortgages. In such a situation, LSC-backing can be established by way of a separate contract or trust that is issued with the notes issued to investors. Primary areas of risk with respect to mortgage-backed securities include prepayment risk, interest rate risk and default risk. LSCs are well suited to protect against default risks particularly if the structure includes a significant number of mortgages that have high-default risks.

Credit card receivables are another common category of structured products. Such structured products are, for example, commonly formed by creating a master trust that holds receivables generated by designated credit card accounts. The master trust issues one or more notes and/or certificates to investors directly or to another entity (e.g., an LLC or another trust) that will issue notes and/or certificates possibly with different classes. Depending on current law and regulations and tax implications, such credit card based transactions may not allow a mixing of asset types, which would result in requiring LSC-backing by way of a separate agreement or trust.

Another major asset category is collateralized debt obligations (“CDOs”). Such structured products typically involve a mix of assets. Typically, a pool of financial assets, such as corporate bonds, derivatives, debt obligations, etc. are aggregated within an entity (e.g., an off-shore trust) and notes are issued to investors. The entity could then include LSCs in the mix of assets or could enter into a separate agreement for providing LSC-backing.

Other applicable areas of structured financial products include collateralized bond obligations (“CBOs”) and hybrids thereof. Examples of such structured financial products and implementations thereof are illustrated in the book “Asset Securitization Comptroller's Handbook,” November 1997, Comptroller of the Currency Administrator of National Bank.

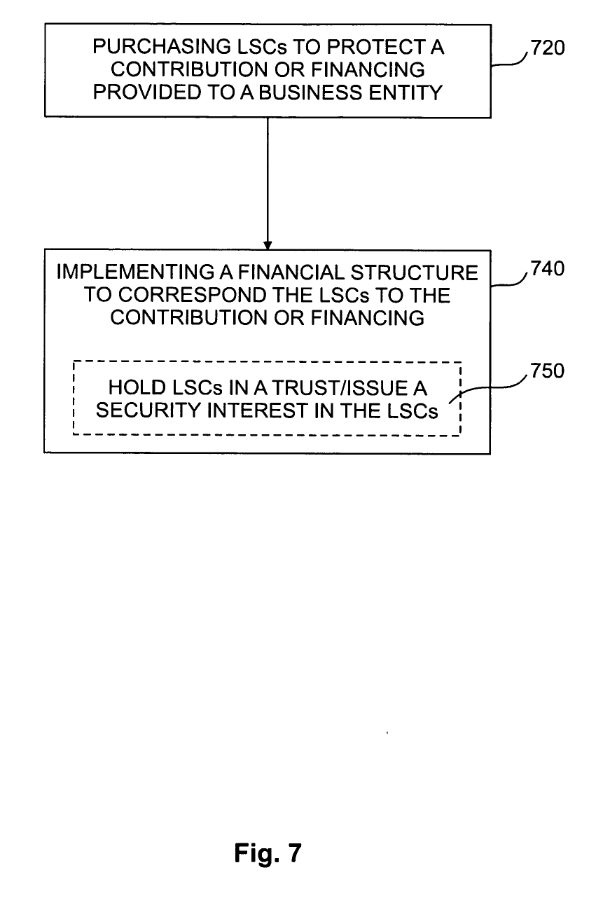

In connection with investments with business entities, a consideration for investors is how to protect the LSCs from other creditors of the business entity. Illustrative steps involved in securing LSCs, which correspond to investment contributions in a business entity are shown in FIG. 7. At step 720, LSCs are purchased to protect a specific contribution or financing provided to a business entity. At step 740, a financial structure is implemented to provide a direct correspondence between the purchased LSCs and the investment contribution or financing. At step 720, the LSCs can be purchased such that a selected Hedge Ratio (the ratio of the face value of the LSCs to the face value of the investment contribution or financing) is secured by way of the LSCs. Step 740 can be implemented, for example, by establishing a trust that would hold the purchased LSCs (e.g., for the benefit of the investors). Alternatively or in combination therewith, the transaction can be such that a security interest in the LSCs is granted to the investors. The grant of the security interest provides the investors with a senior position against other creditors with respect to the LSCs.

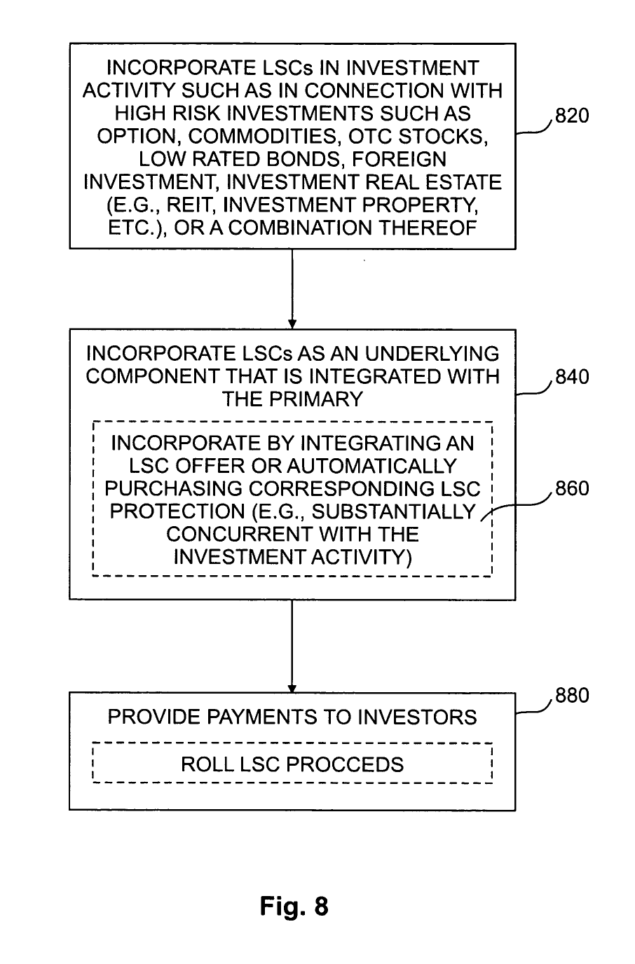

LSCs can be used in combination with various other investment activities. Illustrative steps involved in incorporating LSCs with various high-risk investments are shown in FIG. 8. At step 820, LSCs are incorporated in investment activity such as a high-risk investment (e.g., options, commodities, over-the-counter stocks, low rated bonds, foreign investment, investment real estate (e.g., REITs, investment property, etc.), or combinations thereof). The combination of the LSC with the high-risk investment permits the investor to establish a direct hedge for the high-risk investment at the same time of entering into the high-risk investment. LSCs can be incorporated with such investments in various ways. For example, at step 840, LSCs can be incorporated as an underlying component of the investment that is integrated with the high-risk investment to form a “hybrid” investment. At step 860, which can be part of step 840, the investor can be presented with an offer or opportunity to integrate an LSC with an investment when the investor is purchasing or entering into the investment. For example, an electronic interface can be implemented that offers the investor the option to select LSC-backing for the current investment (e.g., an investment that is offered or entered into substantially concurrent with receiving the LSC offer). Another option is to provide a feature that automatically purchases LSCs as a form of protection when the investor enters into a high-risk investment. At step 880, payments are made to investors as a result of the performance of the integrated product. If desired, depending on the state of the primary investment, which would be the high-risk investment, LSC proceeds can be rolled into the primary investment or rolled into purchasing additional ownership interests in the primary investment. Such activity can occur automatically or may be user-optional per the terms of the investment. The activity can also be automatically implemented and administered by computer equipment.

A user interface and supporting computer system can be implemented to expand the benefits of LSCs to a greater scope of investors and investment opportunities. The focus would be to present a primary investment opportunity and a secondary investment opportunity that is offered to establish a desired hedge against a loss of investor contributions. The desired hedge would be on the basis of the performance of LSCs that are selected based on factors such as the expected investment performance, duration of the primary investment, or date(s) of return of capital. The secondary investment would be distinct from the primary investment in that it is a hedging tool that includes LSCs as its principal component for its performance. As such, the primary investment can be an investment that is other than in LSCs and the secondary investment is directed to LSCs. The relationship between the primary and secondary investments would be such that secondary investment is to hedge the loss of the investor's contribution in the primary investment with LSCs and their proceeds (e.g., purchase LSCs to a face value that matches the investor's contribution in the primary investment).

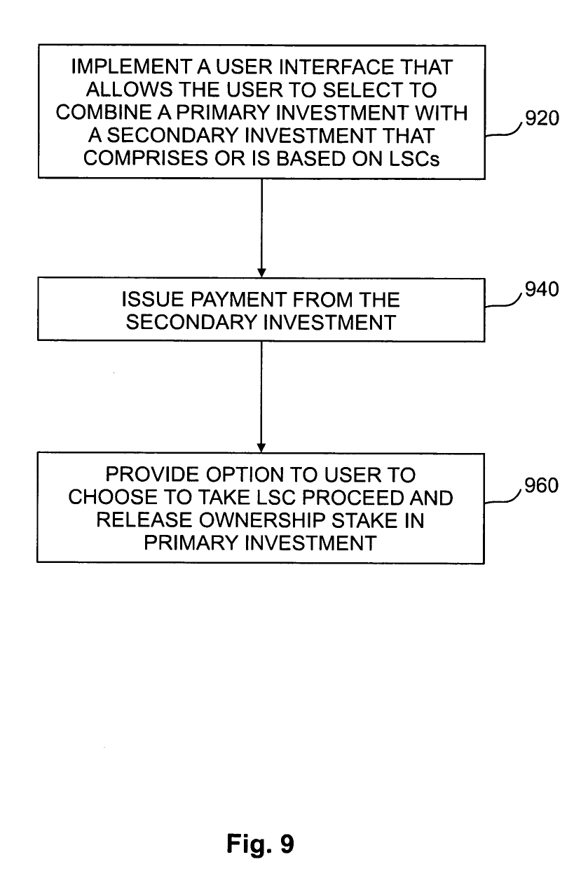

Illustrative steps involved in electronically combining a primary investment with a secondary LSC-based investment are shown in FIG. 9. At step 920, a user interface is implemented that allows users to select to combine a primary investment with a secondary LSC-based investment. The user interface can be presented via a browser or may be part of a separate application. The interface may also include other components such as a fee structure in which a user is informed of different transaction fees if an investment is solely for the primary investment or if the investment is to incorporate the secondary investment. At step 940, payments are issued from the secondary investment to an investor who selected to incorporate the secondary investment. If desired, as mentioned above, protection for the “tail” of LSCs can be a component of a secondary investment. At step 960, the user interface can be implemented to include an option for the user to select to receive LSC proceeds and to release a corresponding ownership stake in the primary investment. With this option, the final maturity date of the investment can be accelerated to avoid the need to wait to determine the outcome of the primary investment before receiving or selecting to receive LSC proceeds.

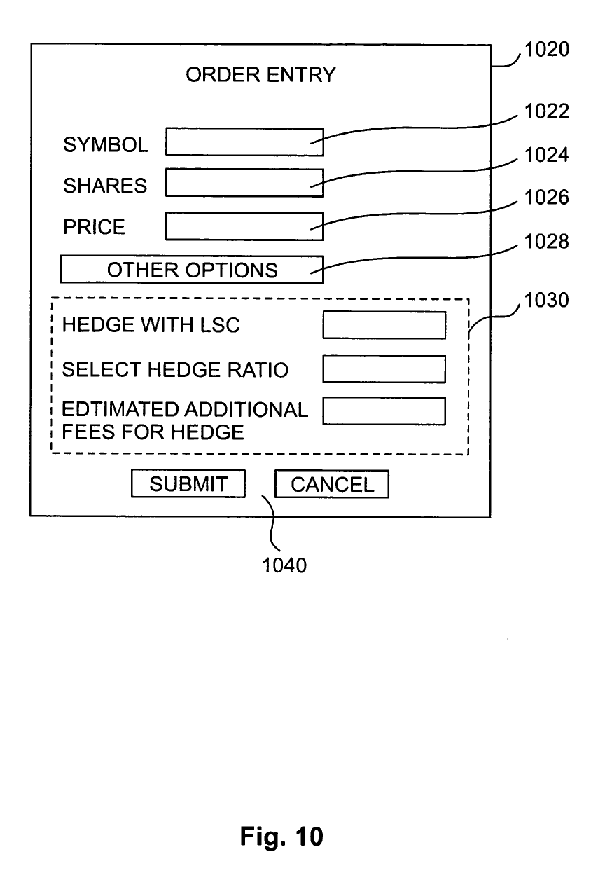

A diagram of a user interface screen is illustratively shown in FIG. 10. Order entry screen 1020, as shown, includes symbol entry area 1022, share entry area 1024, price entry area 1026, other options area 1028, LSC region 1030, and submit/cancel buttons 1040. Different configurations, options, text, and sequences of screens can also be implemented to provide the functionality of screen 1020 in different ways.

Screen 1020 may be displayed after a sequence of one or more earlier screens that led up to screen 1020. Symbol area 1022 is an area in which the identity or identifier for a primary investment can be entered or automatically displayed. For convenience, screen 1020 uses the terms “symbol” and “share” as its nomenclature. However, the interface should not be understood to, for example, be limited to publicly traded securities. In shares area 1024 and price area 1026, the user can enter information specifying the size of the primary investment. Other options area 1029 can be selected to display other categories of related transaction options (e.g., fill-or-kill). LSC region 1030, as shown, is an area in which the secondary investment can be selectably configured by the user. Region 1030 includes an option that a user can select to hedge the primary investment with the secondary investment. Region 1030 can specify a hedge ratio or can provide the user with an opportunity to specify a hedge ratio. Region 1030 can also include an area in which additional investment contribution needed for completing the secondary investment and any additional transaction fees can be estimated and displayed. Submit/cancel buttons 1040 can be used to enter the order or exit the order entry screen 1020.

New tradable products that include LSCs as a secondary component can also be implemented. For example, conventional tradable products such as stocks or options can be structured to be integrated with an LSC component either by way of the formation documents for issuing a stock or option or by a concurrent transaction of LSCs that is directly associated with the issuing stock or option.

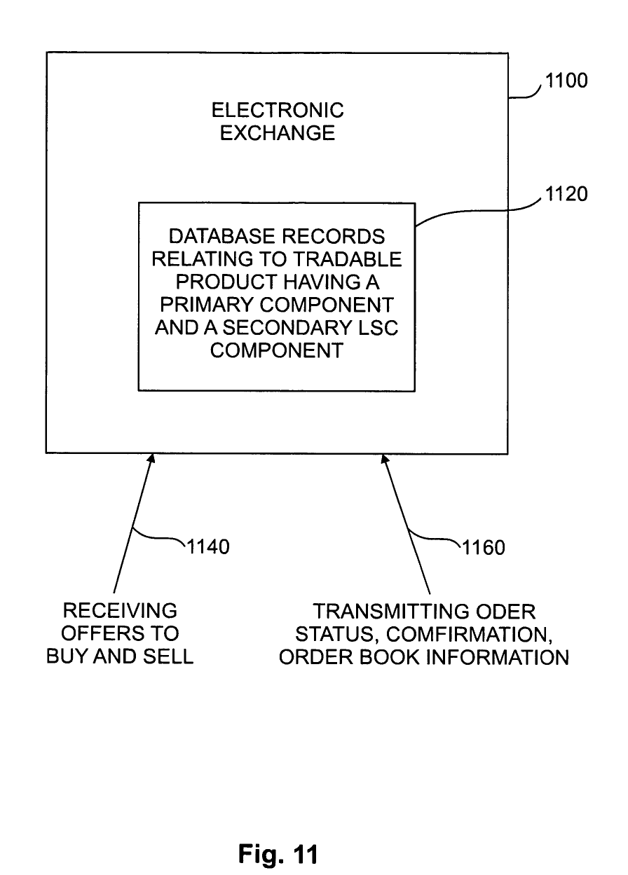

FIG. 11 shows a functional block diagram of an electronic exchange that establishes an electronic market for trading such tradable products. FIG. 11 shows an electronic exchange that can, for example, be implemented in software, hardware, or a combination thereof. In one embodiment, exchange 1100 is implemented using computer equipment (e.g., one or more computers) on which specialized software for providing the functionality needed for an exchange such as matching, order books, record keeping, reconciliation, etc. is implemented. If desired, exchange 1100 may also implement or support a user interface for traders. A user interface such as order entry screen 1020 of FIG. 10 may be used or a variation thereof in which there is no region 1030 implemented within screen 1020 because the tradable product as represented by a particular symbol would already include a secondary LSC component. Exchange 1100, as shown, includes database 1120. Database 1120 is preferably storage for records relating to the tradable products, which have a primary component and a secondary LSC component. The records would therefore at least be unique within an exchange in that they include an LSC-based performance component as a secondary investment of the tradable product. Exchange 1100 receives messages 1140 containing offers to buy or sell the tradable product. Exchange 1100 can also transmits messages 1160 to traders that can contain order status, confirmation, order book information, or other exchange information, which can be based on or from database 1120. The messages can be sent via a communication channel. The communication channel can be one or more communication connections that may include wired, wireless, or a combination thereof that is suitable for carrying the exchange's load.

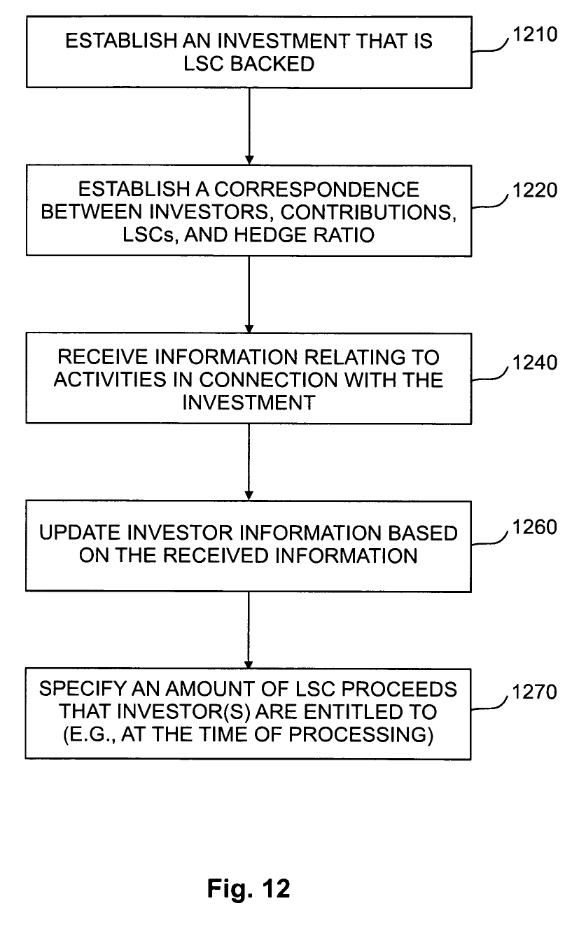

The administration and management of an LSC backed investment is preferably implemented on computer equipment. Illustrative computer implemented steps for administering and managing an LSC-backed investment are shown in FIG. 12. At step 1210, an investment that is LSC backed is established (e.g., a structured financial product is formed). At step 1220, a correspondence is established to specify a relationship between investors, contributions, LSCs, and Hedge Ratio. The correspondence can be recorded in a database for update and retrieval. At step 1240, information relating to the occurrence of activities in connection with the investment is received and if desired, recorded. The activities can, for example, include investment performance, the size of ownership interests in the investment, investor contributions, fees, the status and proceeds from LSCs, or other activities that would be related to the investment or related records (e.g., address or identity information of investors).

At step 1260, investor information, for example, ownership interest, Hedge Ratio (if, for example, more than one was used), principal, contributions, or payment history is updated based on the information received at step 1240. At step 1270, based on the stored information and the performance of the investment, an amount that is to be paid to an investor is calculated and specified so that a corresponding payment can be issued. As such, calculations for individual investors can be implemented. In addition, the amount can vary depending on the current maturity of the investment.

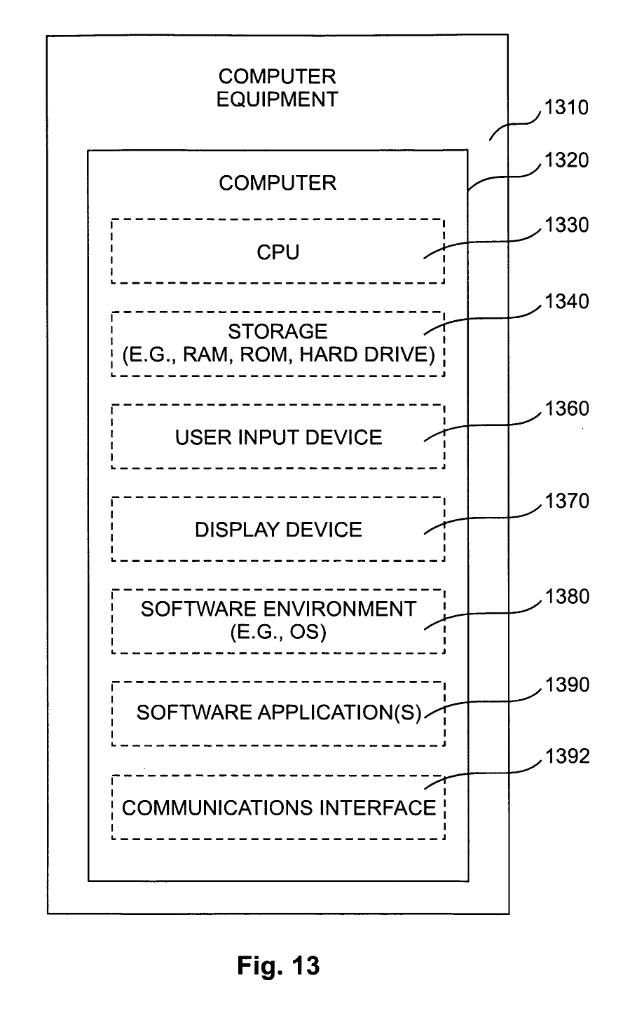

Various steps or process illustratively described herein can be implemented using computer equipment. FIG. 13 is a functional block diagram of illustrative computer equipment for implementing such steps and processes. Computer equipment 1310 can, for example, include one or more computers 1320 (e.g., computers that networked by way of a WAN, LAN, etc.). Computer 1320 can be a personal computer, a workstation, a server, or other computer device having sufficient processing, storage, and communications resources for performing one or more steps or processes illustratively described herein. Computer 1320 preferably includes CPU 1330, storage 1340 (e.g., ROM, RAM or hard drive), user input device 1360 (e.g., keyboard, mouse), display device 1370 (e.g., a monitor), software environment 1380 (e.g., operating system), software application(s) 1390 (e.g., browser, user interface, electronic exchange software, etc.), and communications interface(s) 1392 (e.g., to network computers and receive data). Information such as database records for an exchange can be stored in equipment such as computer 1320.

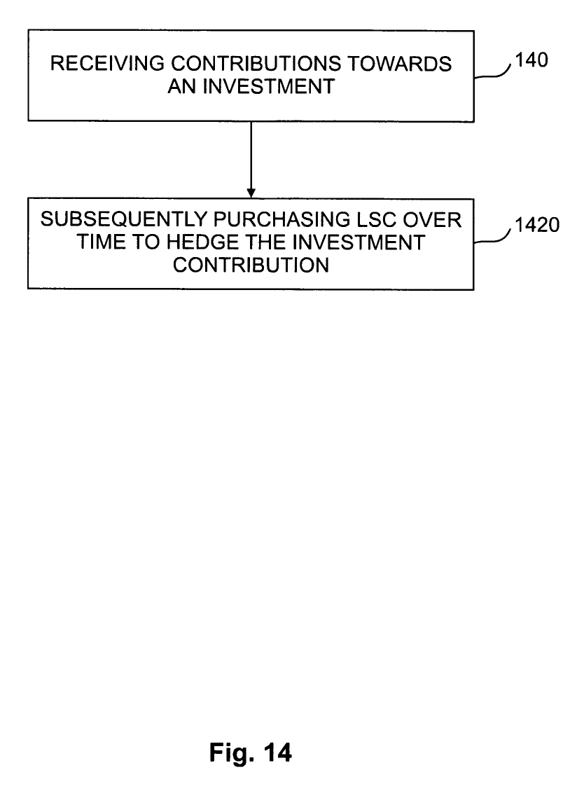

Another implementation of LSC-backed investments can involve purchasing LSCs over time to establish a hedge against a primary investment. For example, with reference to FIG. 14, at step 1410, contributions towards a primary investment are received. At step 1420, subsequent to receiving contributions, LSCs are purchased over time to hedge the investment contribution. As such, there can be a gap in time between, for example, when the initial contribution is made, and corresponding LSCs are purchased. For example, LSCs are first purchased when the investment provides an initial return on investment. This way the initial contribution would not necessarily need to support the purchase of LSCs but subsequently received income of the investment would be used to purchase LSCs. A combination of initial purchase and delayed purchase of LSCs for protection purposes could also be used.

The steps as shown in the FIGS. are presented in a particular order. However, those of ordinary skill in the art will understand that the steps may not necessarily have to be performed in the exact order as shown. Variations in order as may be suitable are contemplated.

It is to be understood that the invention is not to be limited to the exact configuration as illustrated and described herein. Accordingly, all expedient modifications readily attainable by one of ordinary skill in the art from the disclosure set forth herein, or by routine experimentation there from, are deemed to be within the spirit and scope of the invention as defined by the appended claims.

What is claimed is:

1. A method of investing, comprising:
investing funds in a business entity; and
obtaining an interest in one or more life settlement contracts (LSCs) as protection against the loss of a percentage of the invested funds.

2. The method of claim 1, wherein an investor receives an equity interest in the business entity in return for its invested funds.

3. The method of claim 2, wherein the equity interest includes a warrant exercisable for stock.

4. The method of claim 3, wherein the investor receives a debt interest in the business entity in return for its invested funds.

5. The method of claim 4, wherein the debt interest provides for repayment forbearance for at least one year.

6. The method of claim 1 wherein the LSCs are held in escrow when the funds protected by the LSCs remain invested in the business entity.

7. A method for providing an integrated investment product comprising:
establishing an investment fund that hedges a financial investment of its investors with LSCs; and
returning at least a portion of the financial investment of one or more of the investors from proceeds of LSCs.

8. The method of claim 7 wherein the investment fund invests in startup companies.

9. The method of claim 7 wherein the investment fund invests in collateralized debt obligations (CDOs) or other structured financial products.

10. The method of claim 7 wherein the fund pays for ongoing premiums of the LSCs.

11. The method of claim 7 wherein the LSCs are held in escrow for the benefit of the investment fund.

12. The method of claim 7 wherein the LSCs are held in escrow for the benefit of the investors.

13. The method of claim 7 wherein one or more investors are paid from the proceeds of LSCs if the investments made by the fund with the investor's contribution fails or another significant financial event occurs.

14. The method of claim 7 wherein the investment fund enters into a binding obligation to associate each investor's contribution with LSCs.

15. A method for providing an investment product to investors, comprising:
offering an investment to investors that has an intended revenue generating source that is other than LSCs; and
integrating LSCs into the investment to protect a percentage of the financial contribution of the investors.

16. The method of claim 15 wherein the investment is a structured financial product.

17. The method of claim 15 wherein the investment is an operating start-up company.

18. The method of claim 15 wherein the integrating comprises purchasing LSCs.

19. A method of debt or principal-hedging, comprising:
providing a known maturity date to the investment; and
purchasing LSCs to protect principal invested in the investment, each LSC in the pool having an expected maturity date less than or equal to the known maturity date.

20. The method of claim 19 further comprising purchasing insurance for the LSCs, wherein for each LSC that has not matured as of the maturity of the investment, the insurance makes a payment up to and including a face value of that LSC.

21. The method of claim 19 further comprising implementing a user interface for selecting to integrate LSCs with a primary investment.

22. The method of claim 19 further comprises issuing a tradeable product having the LSC as a secondary component and trading the product on an electronic exchange.

23. The method of claim 19, further comprises creating a structured product comprising the pool of LSCs.

24. The method of claims 23, wherein the structured product comprises a mix of different types of assets in addition to the pool of LSCs.
